(19) United States
(12) Patent Application Publication
(10) Pub. No.: US 2021/0077945 A1
(43) Pub. Date: Mar. 18, 2021

(54) ELBOW TYPE GAS PURIFIER AND METHOD OF ITS PRODUCTION

(71) Applicant: MECHEM LAB LTD., Nesher (IL)

(72) Inventors: Konstantin CHUNTONOV, Migdal Haemek (IL); Boris VERBITSKY, Haifa (IL)

(73) Assignee: MECHEM LAB LTD., Nesher (IL)

(21) Appl. No.: 16/603,218

(22) PCT Filed: Jun. 14, 2017
(86) PCT No.: PCT/IB2017/053518

§ 371 Date: Oct. 4, 2019

Related U.S. Application Data
(60) Provisional application No. 62/601,957, filed on Apr. 7, 2017.
(60) Provisional application No. 62/514,936, filed on Jun. 4, 2017.

(30) Foreign Application Priority Data
Jun. 6, 2017 (IB) PCT/IB2017/053325

(51) Int. Cl. B01D 53/04; B01D 53/047

(52) U.S. Cl. CPC B01D 53/0446; B01D 2253/1122; B01D 2259/40084; B01D 53/047

(57) ABSTRACT

Elbow type gas purifier with powder reactant and continuously operating purity indicator of gas product, created on the basis of a flow meter, form, with a sequential connection, a system that is a gas cleaning equipment of a new class.

### I. FIELD OF THE INVENTION

The given invention refers to the field of purification of stream gases, in particular, to gas purifiers with a purity indicator.

### II. BACKGROUND

Gas purifiers are widely used in the production of high purity gases. Generally, these are flow tubes with porous sorbent, which captures impurities in the gas. While impurities are collected in the sorbent, the capturing rate decreases, which leads to monotonous decrease of the purity of the gas coming out of the gas purifier.

None of the known types of gas purifiers renders a service of defining an impurity concentration in the product of purification. However, the users of high purity gases need to know the purity level of the gas they use and for many of them this is vitally important. The latter case covers those process systems, where the quality of the end product directly depends on the purity of the used gas. At the same time the existing methods of measuring the purity of stream gases are practically unavailable for the majority of the users due to high costs of the precision analytical equipment and its operation.

Accordingly, there is a need for modernization of gas purifiers, for example gas purifiers with activationless getter powders based on reactive metals and alloys [U.S. Pat. No. 9,586,173]. The present invention targets the solution of said problem of quality control of the end gas product with regard to gas purifiers.

### III. SUMMARY

The modified gas purifier according to the present invention has a number of improvements of both design and functional character.

First, in one embodiment a vacuum charging of the vessel with reactive powder, which required special pressing and welding equipment, is replaced for an easier and more convenient method of filling/sealing in the flow of argon at the small excess of the pressure over the atmospheric pressure.

In a second embodiment, the known vessel having a filling tube welded to it is replaced with an extended metallic pipe, which can be coiled into a spiral coil. This reduces production costs and also increases the lifetime of the getter powder.

In a third embodiment, an improved gas purifier as distinct from the prior art provides the users with the information about the current purity of the end gas product. According to the given embodiment, a flow meter, the readings of which are calibrated in the units of purity of the gas coming out from the gas purifier, serves as a purity indicator.

In addition, the gas purifier of the present invention may be provided by modification of known gas purifiers with low costs and effort. Thus, the techniques disclosed herein are applicable to a broad field of gas purification applications.

### IV. BRIEF DESCRIPTION OF THE DRAWINGS

FIG. 1(a) is a scheme of charging (filling) a vessel with reactive powder according to one embodiment of the present disclosure.

FIG. 1(b) is a scheme of charging (filling) a vessel with reactive powder according to a state of the art technique.

FIG. 2 shows the design of the modified gas purifier according to one embodiment of the present disclosure.

FIG. 3 shows a dependency of the quality of the gas product on the quantity of the treated gas according to one embodiment of the present disclosure.

FIG. 4 shows a sorption system according to one embodiment of the present disclosure.

### V. DETAILED DESCRIPTION OF THE DISCLOSED EMBODIMENTS

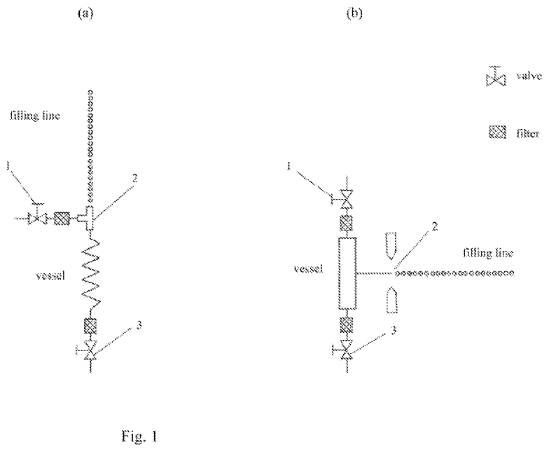

A gas purifier, e.g. one using reactive powder for gas purification, has a gas tight vessel, an inlet and an outlet with a filter and a valve each, and a charging port, which has to be tightly closed after filling. The procedure of charging the vessel with powder and the further operations for sealing the vessel are shown in FIG. 1.

According to the prior art the vessel is filled with powder coming from the vacuum mill [U.S. Pat. No. 9,586,173] along the metallic pipe (see filling line in FIG. 1(b)), which is connected with the vessel by welding. Valves 1 and 3 at this are closed. After filling the powder the pipe is cut off without breaking the vacuum by pinching [Less-Common metals, 83 (1982) 143-153]. The place of the formation of a hermetic seal is shown in FIG. 1(b) with arrows.

The improved gas purifier according to one embodiment of the present disclosure is charged (filled) with powder under argon and is then tightened already in the flow of argon (FIG. 1, a). The metallic pipe going from the vacuum mill (dotted line on top of FIG. 1(a)) is connected to the vessel via Tee 2 (e.g. Tee Type Safety Head from HiP, Union Tee from Swagelok, etc.). Two other ends of Tee 2 are connected to the gas line, one via valve 1 and another one via the vessel and valve 3. That is, the upper end of the Tee serves for filling of the powder fed from the mill

Before milling the ingot, the vacuum mill is filled with argon through valve 1 (while valve 3 is closed) till the pressure of ˜1 bar. Then, the powder is produced and pours along the metallic pipe and Tee 2 into the vessel. As soon as the vessel is filled with the powder, argon is fed into the system gas purifier/mill through valve 1 creating a small gas stream towards the mill.

Then the metallic pipe leading to the mill is disconnected from Tee 2 and closed in a standard way, e.g. with the help of a plug or a cap in the flow of exiting argon coming from line of valve 1. If the gas to be purified is argon, then the gas purifier is ready to work; if it is another gas, then it is necessary to clean the vessel with the gas to be purified using valves 1 and 3.

So, compared with the prior art [U.S. Pat. No. 9,586,173, see FIG. 1(b)] two useful changes are introduced into the design of the modified gas purifier. First, instead a reservoir with a welded to it filling tube an extended metallic pipe, which can be coiled into a spiral coil, is used in the present invention. This simplifies the manufacturing of the vessel and improves the working characteristics of the gas purifier.

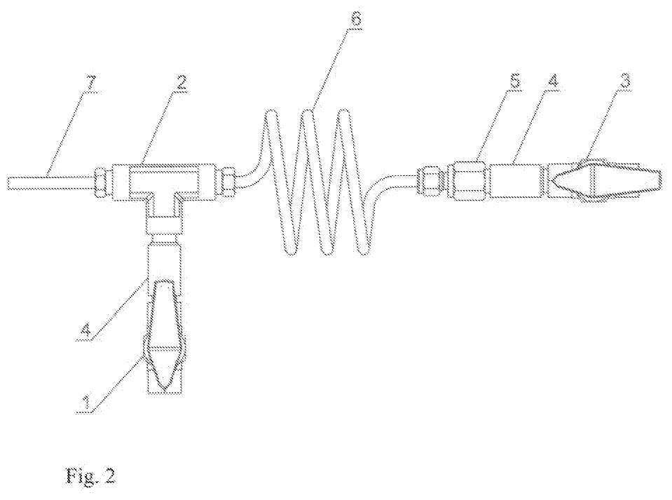

Second, due to the employment of a Tee it is now possible to operate in the flow of argon (which is a less expensive method) instead of using the vacuum filling/sealing of the vessel. Besides, now a layer by layer filling of the vessel with materials of different composition is also possible. With the appearance of a Tee the geometry of the gas stream also changes, which turns the modernized gas purifier from the sorption column of an in-line type into an elbow type column. One of the examples of the modernized elbow type gas purifier with a powder reactant is given in FIG. 2. However, this embodiment is not limited to the specific design shown in FIG. 2.

Finally, one more advantage of elbow gas purifiers is the developed in application to it method of defining the purity of the end gas product. The problem of detecting impurities of the gas stream needs here a different engineering solution and a different theoretical basis than in the case of, e.g. reactive sorbers.

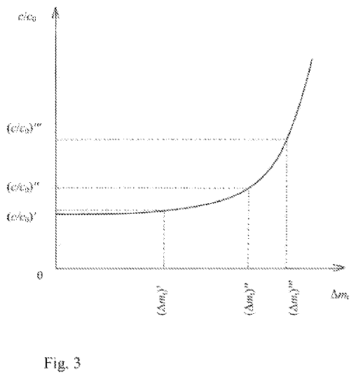

The authors found that the best instrumental basis for monitoring the quality of the purified gas will be a gas flow meter installed in the gas line with the gas purifier as will be set forth in the disclosure of one preferred embodiment below. As it follows from the equation of material balance for the sorption process in a flow tube with reactive powder Me, concentration c of impurity Y in the exit of the tube grows with the amount of flown through it gas (FIG. 3). This run of the curve c is the consequence of two reasons: the powder structure of the reactant and the decrease of the active share of the sorbent in the process of gettering gas Y.

The dependence presented in FIG. 3 of c from Δmₜ, where Δmₜ is the amount of gas flown through the tube by the moment of time t, has a fundamental character. If we standardize the process conditions demanding the constancy of such values as the size of the powder particles, the length of the powder column in the flow tube, the rate of the gas stream, the porosity of the powder charge and the initial impurity concentration then the built up for an arbitrary pair Me−Y curve c=c(Δmₜ) will be completely reproduced each time when the same conditions are repeated. It follows from here that either the readings of the flow meter can be calibrated in the units of purity of the end gas product or the signal from the flow meter can be transmitted to the separate display with the device, which converts the data of the flow meter into the values of concentrations of gases.

For the creation of a program for translating the values obtained by measuring the amount of gas Δmₜ passing through the gas purifier into the values c of the concentration of gas impurity in the exit of the gas purifier it is necessary to build up an experimental curve c=c(Δmₜ). These curves appear as a result of calibration tests with participation of precision analytical equipment, e.g. like Atmospheric Pressure Chemical Ionization Mass Spectrometer. So, analyzing the gas sample taken at the value (Δmₜ)′ we obtain the value of the concentration (c/c₀)′, then analyzing the gas sample taken at the value (Δmₜ)″ we obtain the value of the concentration (c/c₀)″; repeating this procedure at (Δmₜ)′″ we find the corresponding to it value (c/c₀)′″. Proceeding in this way we find the position of the entire curve (FIG. 3). Then, using the obtained data an algorithm for translation the readings of a flow meter into the readings of a mass spectrometer is built up.

The said procedure limits the role of the complex and expensive analytical equipment like mentioned mass spectrometer as a temporary participant in working out an algorithm for a simple purity indicator on the basis of a flow meter.

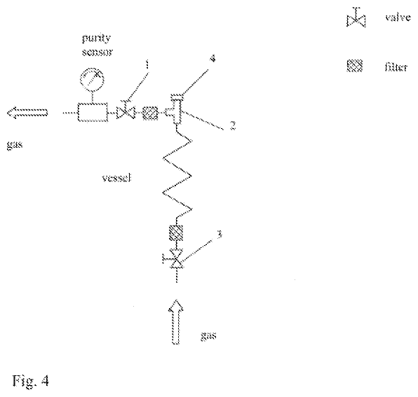

Integration of this kind of indicator with an elbow type gas purifier (FIG. 4) provides a solution of the problem of quality control of the end gas product. It should be noted that the position of the flow meter in FIG. 4 is illustrative only and alternative positions for the flowmeter upstream or downstream of the depicted position are also feasible for the present invention as disclosed herein.

Summarizing the above said, we see that the presented in FIG. 4 system of the two connected in sequence gas units, an elbow type gas purifier and an adjusted to the purity indicator flow meter, satisfy two most important for today needs in the field of gases—the increase of the efficiency of the sorption processes and enhancing the economic security of the technologies, which use high purity gases as the initial product.

FIG. 1. Scheme of charging (filling) the vessel with reactive powder.

(a) filling in the atmosphere of argon (the new method):

1—a valve, 2—Tee, 3−a valve; the reference to “filling line” should be understood only as an indication of the position of the metallic pipe, along which the powder is fed from the mill to the vessel; after charging the powder into the vessel the pressure of argon is increased through valve 1 till the small excess over the outside pressure , metallic pipe is disconnected from Tee 2 and the latter is closed by a plug or a cap under the conditions of argon coming out from 2.

(b) filling under vacuum (prior art):

1—a valve, 2—place of formation of a hermetical seam, 3—a valve.

FIG. 2. Design of the improved (i.e. modified) gas purifier.

1—an outlet valve, 2—a Tee, 3—an inlet valve, 4—a filter, 5—a connector, 6—a vessel in a form of a coil pipe, 7—a metallic pipe.

Depending on the character of the application vessel 6 can be made of stainless steel or other metallic material, glass, polymers, etc.

FIG. 3. Dependence of the quality of the gas product on the quantity of the treated gas.

c—the concentration of the impurity in the end product, c₀—the initial concentration of the impurity while the amount of Δmₜ passed through the gas purifier is the value Δmₜ=kpvt, where p—gas pressure, v—gas rate, t—time, and k is a coefficient, which depends on c₀ and on the length of the powder column.

The most economical method of building up the curve c/c₀=f(Δmₜ) is the theoretical solution of the problem on gas concentration in the exit of the gas purifier and correction of the obtained curve using experimental data.

FIG. 4. Sorption system

1—an outlet valve, 2—a Tee, 3—an inlet valve, 4—a cap.

Sequential connection of the elbow type gas purifier with powder reactant Me and a purity indicator on the basis of a flow meter leads to the appearance of gas purification equipment of a new class, with high sorption efficiency and continuous estimation of the impurity concentration in the products of purification.

1. A gas purification system, comprising:
a gas purification vessel having a gas input port and a gas output port;
a Tee having a first end, a second end, and a third end in flow connection to another, wherein the first end of the Tee is connected to the gas purification vessel,
a feed line for sorption material connectable to the second end of the Tee; and
an output line for purified gas connected to the third end of the Tee, comprising a first valve, and connectable to a source of inter gas.

2. The gas purification system according to claim 1, wherein a second end of the Tee is a port for the input of sorption material and a third end of the Tee is an output end for purified gas and an input port for inert gas.

3. The gas purification system according to claim 1, wherein the gas purification vessel has a helical shape or coil shape.

4. (canceled)

5. The gas purification system according to claim 1, further comprising a flow meter arranged in the output line for purified gas or between the output line for purified gas and the gas purification vessel.

6. The gas purification system according to claim 5, wherein the flow meter is connected to means for converting flow data of the flow meter into values of concentration of gas in the exit from the gas purification system.

7. The gas purification system according to claim 6, wherein an algorithm for converting the data of the flow meter into the values of gas concentration is built up according to the results of direct measurements using precision analytical equipment.

8. The gas purification system according to of claim 1, further comprising an input line for gas to be purified connected to the gas input port of the gas purification vessel and comprising a second valve.

9. The gas purification system according to of claim 8, further comprising a first filter arranged in the input line for gas to be purified and a second filter arranged in the output line for purified gas.

10. The gas purification system according to of claim 1, wherein the sorption material is powder produced from an alloy of reactive metals.

11. Method of filling a gas purification system according to anyone claim 1, comprising:
enabling a flow of inert gas into the third end of the Tee to purge the gas purification system with inert gas;
connecting a feed line for sorption material connectable to the second end of the Tee in the flow of inert gas and feeding sorption material into the gas purification system;
after completion of the feeding, disconnecting the feed line for sorption material during enabled flow of inter gas from the third end of the Tee to prevent ambient gas from entering the gas purification system; and
sealing the second end of the Tee.

12-13. (canceled)
